(19) United States
(12) Patent Application Publication
(10) Pub. No.: US 2014/0316804 A1
(43) Pub. Date: Oct. 23, 2014

(54) MEDICAL STAFF MESSAGING

(71) Applicants: Thanh H. Tran, San Jose, CA (US); Alon Segal, Herzlia (IL)

(72) Inventors: Thanh H. Tran, San Jose, CA (US); Alon Segal, Herzlia (IL)

(21) Appl. No.: 14/353,533

(22) PCT Filed: Jul. 15, 2012
(86) PCT No.: PCT/IL2012/050246

§ 371 Date: Apr. 23, 2014

Related U.S. Application Data
(60) Provisional application No. 61/551,584, filed on Oct. 26, 2011.
(60) Provisional application No. 61/587,110, filed on Jan. 16, 2012.

(51) Int. Cl. G06Q 10/10; H04L 12/58; G06Q 50/22; H04L 29/08

(52) U.S. Cl. CPC G06Q 10/1097; H04L 67/12; H04L 51/046; G06Q 50/22
USPC 705/2

(57) ABSTRACT

A method for communicating with relevant medical staff members about identified medical procedures in real time, comprising mapping at least one dataset of medical roles; monitoring a plurality of physiological measures of a patient; automatically identifying, according to an analysis of the plurality of physiological measures and according to the at least one dataset, when a first of the plurality of medical procedures is required in real time; generating a message containing data indicative of the first medical procedure and one or more physiological measures; acquiring scheduling data indicative which of a plurality of medical staff members currently man the plurality of medical roles; selecting at least one of the plurality of medical staff members for the medical procedure according to the scheduling data; and sending the message to the selected at least one medical staff member.

### RELATED APPLICATIONS

This application claims priority from Provisional U.S. Patent Application No. 61/551,584 filed on Oct. 26, 2011 and from Provisional U.S. Patent Application No. 61/587,110 filed on Jan. 16, 2012. The contents of all of the above documents are incorporated by reference as if fully set forth herein.

### FIELD AND BACKGROUND OF THE INVENTION

The present invention, in some embodiments thereof, relates to a system and a method for medical staff real time communication and, more particularly, but not exclusively, to systems and methods for integrating dispersed clinical and non-clinical data sources to infer relationships between health care related entities.

Modern medical diagnostic facilities draw upon a wide range of resources to provide high-quality medical care. Such resources include the physical plant needed to accommodate patients and medical care staff, disposable and non-disposable equipment and resources utilized in providing medical care, and human resources critical in providing the care. Proper management of such facilities, which is subject to the same business constraints as any other highly technical business operation, requires detailed analysis of asset utilization for financial allocation and planning.

Current techniques for managing data in medical facilities include manual and automated collection of data from individual areas, departments, and systems. In a typical institution, assets utilized for patient care are tracked for billing purposes, such as by input into a hospital information system (HIS). Maintenance of more technical resources, such as imaging and monitoring systems, is typically separate from the HIS, and may include records kept by hospital personnel, as well as by on or off-site contractors maintained to support the equipment. Similarly, support personnel employed to maintain the physical plant, including a wide range of equipment and components from lights to building systems, to grounds maintenance, often keep entirely separate records. Moreover, the individual records kept for asset and resource utilization and medical institutions is generally not associated with similar records derived from known populations, or even financial information for the same or similar equipment to permit more detailed asset management.

At present, information resources are often separated both within institutions, and between institutions, even where the institutions are logically associated in a single or related business. Similarly, present techniques do not typically associate centralized records for an institution or medical business with similar data for the purposes of benchmarking, financial analysis or financial tracking.

Health care organizations such as hospitals may have several dispersed data sources containing interrelated information. For example, there may be a central repository which contains administrative information of all patients registered at the hospital. Additionally, each division holds additional (or even the same) information about the diagnoses and treatment of the patients that they have dealt with. Information from another division stored about a patient in one division may be relevant to a (para-) medical professional seeking information from another division.

Existing solutions focused on integrating databases were indicated by the knowledge web network of excellence project (which is funded by the European Commission 6th Framework Programme) as having a tendency to ignore the underlying meaning of the data and its structure so that an intelligent consolidation and presentation is not possible. The Knowledge Web Network of Excellence project recognized the solution as integration and subsequent mediation of medical databases at the semantic level.

### SUMMARY OF THE INVENTION

According to an aspect of some embodiments of the present invention there is provided a method for communicating with relevant medical staff members about identified medical procedures in real time, comprising: monitoring a plurality of medical parameters of a patient during the hospitalization thereof; mapping each of a plurality of medical roles to at least one of a plurality of medical procedures, each of the medical procedure being associated with at least one of the plurality of current medical parameters; automatically identifying in real time, according to an analysis of the plurality of current medical parameters, when a first of the plurality of medical procedures is required; acquiring scheduling data indicative which of a plurality of medical staff members currently man the plurality of medical roles; generating a message containing data indicative of the first medical procedure and at least some of the plurality of medical parameters which are relevant for the first medical procedure; selecting at least one of the plurality of medical staff members for the medical procedure according to the scheduling data; and sending the message to the selected at least one medical staff member.

Optionally, the plurality of medical parameters is extracted from at least one medical monitor who monitors the patient. Optionally, the plurality of medical parameters comprises a member of a group consisting of a blood pressure, an oxygen level in blood, a temperature, and an IV liquid level. Optionally, the scheduling data is indicative which of the plurality of medical staff members' man the plurality of medical roles in a plurality of shifts. Optionally, the method further comprises monitoring a plurality of other patients wherein selecting at least one of the plurality of medical staff members is optimized with respect to a plurality of medical procedures of the plurality of patients. Optionally, at least one of the monitoring, the automatically identifying, the generating a message, the acquiring, the scheduling data the selecting and the sending is performed in real time. Optionally, the method further comprises managing a transition between medical staff members shifts wherein each the medical role has a minimum number of medical staff members and each medical staff member is assigned one of the states: active, active in transition, off-duty, off-duty in transition such that each of the plurality of medical roles is manned by at least the minimum number of medical staff members. Optionally, the method further comprises organizing at least one of the required plurality of medical procedures, the acquired scheduling data and selected medical staff members around a patient entity. Optionally, the method further comprises monitoring a response to the message. Optionally, the method further comprises ensuring continuation of care by redirecting unhandled messages at a transition between medical staff members shifts. Optionally, the method further comprises managing escalation of an unhandled message according to the response monitoring. Optionally, the method further comprises facilitating multidirectional communication between the selected at least one medical staff member. Optionally, the method further comprises forwarding the message to another medical staff member for facilitating collaboration.

According to an aspect of some embodiments of the present invention there is provided a real-time medical staff members' communication system of identified medical procedures, comprising: a medical data interface which receives a plurality of physiological measures for medical parameters of a patient from at least one medical monitor; a staffing tracking unit which monitors which of a plurality of medical staff members currently man a plurality of medical roles, each the medical role being associated with at least one of a plurality of medical procedures each of the medical procedure being associated with a plurality of physiological parameters of the plurality of medical parameters; a computing unit which determines in real time when a first of the plurality of medical procedures is required according to the plurality of physiological measures and selects, in real time, selects a group from the plurality of medical staff members currently which currently man the plurality of medical roles according to the first medical procedure; and a messaging unit which distributes at least one message about the first medical procedure to each member of the group; wherein the message contains patient's physiological measurements relevant to the first medical procedure.

Optionally, at least one message comprises a plurality of messages each adjusted to include a different segment of the plurality of physiological measures. Optionally, the message is selected from a group consisting of: a short message service (SMS) and a multimedia message.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 which is an illustration of a real-time medical staff members' communication system of identified medical procedures, according to an embodiment of the present invention;

FIG. 2 is an illustration of an exemplary implementation of a real-time medical staff members' communication system of identified medical procedures, according to an embodiment of the present invention;

FIG. 3 is a method for communicating with relevant medical staff members about identified medical procedures in real time, according to an embodiment of the present invention;

FIG. 4 is an illustration of a medical staff member status transition upon signing in to a communication system, according to an embodiment of the present invention;

FIG. 5 is an illustration of medical staff member information 501 and physical organization data of a care unit utilized for selecting at least one medical staff member for a medical procedure, according to an embodiment of the present invention;

FIG. 6 is a screen shot of an application implementing a real-time medical staff members' communication system of identified medical procedures, according to an embodiment of the present invention; and

FIG. 7 is an illustration of a message for a medical staff member, according to an embodiment of the present invention.

### DESCRIPTION OF EMBODIMENTS OF THE INVENTION

The present invention, in some embodiments thereof, relates to a system and a method for medical staff real time communication and, more particularly, but not exclusively, to systems and methods for integrating dispersed clinical and non-clinical data sources to infer relationships between health care related entities.

According to one embodiment of the present invention, there are methods and systems for detecting medical events pertaining to specific patients and informing, in real time, the relevant medical staff members about the medical events while automatically providing them with the suitable medical information. The communication system monitors medical data from the medical monitoring devices, detects medical events, gathers inputs from orthogonal data sources, and determines to which personal(s) suitable medical data should be sent upon detecting medical events based on the data from the orthogonal data sources. For example, nurses shift data is typically managed through a different system than doctors shift data. Billing and administration systems do not typically communicate with staffing systems. By bringing these inputs together with real time medical data gathered from medical monitors who monitor in real time different patients the system automatically identifies abnormal measurements, compares compliance with hospital policies and/or suggests required medical procedures. Exemplary medical procedures include administrating a drug, replacing an IV, measuring blood pressure, taking an x-ray etc. Each medical procedure is associated with one or more medical parameters. The system identifies the relevant staff members and provides them with the medical information which is required for performing the medical procedures. The communication system improves health care quality delivered to a patient by shortening response time, helping care givers monitor changing physiological measurements in real time and/or insuring continuation of care by minimally changing medical staff members.

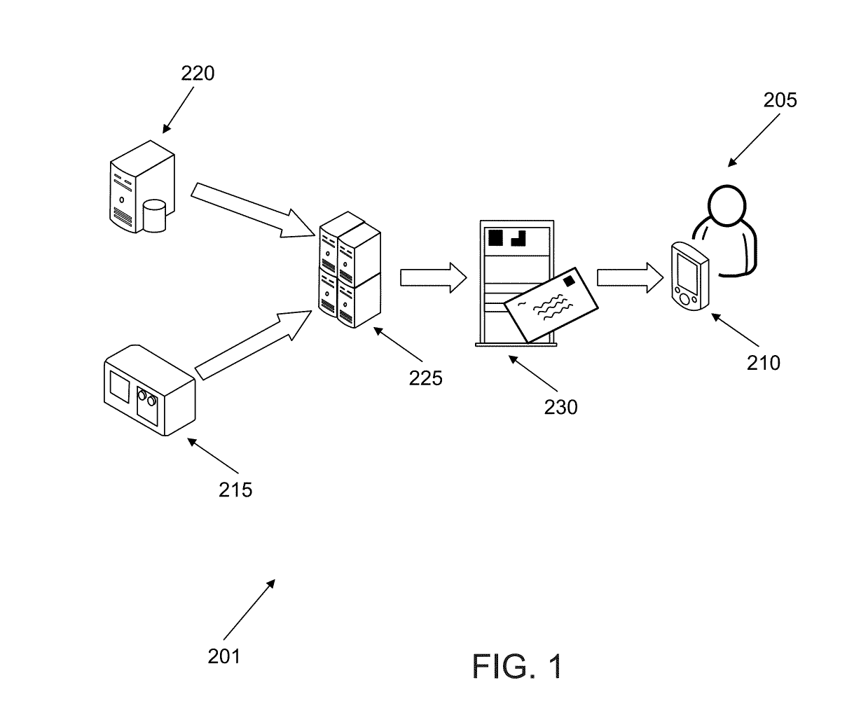

Reference is also made to FIG. 1 which is an illustration of a real-time medical staff members' communication system of identified medical procedures, according to an embodiment of the present invention. A medical data interface monitor 215 receives a plurality of physiological measures from a plurality of medical monitoring devices, referred to herein as medical monitors, which monitor medical parameters, such as vital signs and physiological measurements in real time. As used herein, the term medical parameters means categories of measureable variables and/or descriptive variables which characterize a medical condition and/or factors related to and/or associated with a medical condition. For example an x-ray is associated with the following medical parameters: imaged organ, the amount of radiation used, the technician notes etc. Medical parameters, measured in real time, may be combined with measured medical parameters which are recorded in the file of the patient, such as blood pressure, organ imaging data such as C.T., MRI and/or x-ray, counts of factors in blood such as, for example, red blood cells, a specific cytokine and/or a hormone. A physiological measurement may be represented by a number, a range of numbers, a color indicator, an image, results of image analysis and/or a tag such as disease stage, chemical existence. A physiological measurement may be accompanied by a confidence level measurement. A staffing tracking unit 215 receives data from one or more staffing system to monitor which of a plurality of medical staff members 205 currently man a plurality of medical roles. Exemplary medical roles comprise: a surgeon, a registered nurse, a medical administrator and/or a billing agent. Each medical role is associated with one or more medical procedures. The staffing system(s) may be a central logging system, a set of dispersed logging systems, one or more staffing applications and/or forms stored in one or more client terminals, such a laptop, a desktop, a tablet, and Smartphone. Each medical role is associated with one or more of a plurality of medical procedures and one or more patients and/or patient beds. Exemplary medical procedures comprise: drug administration, preparation for surgery, measuring blood pressure, replacing bandages, hooking to monitor, replacing IV etc. Each medical procedure is associated with a range of values of a plurality of medical parameters. For example: a prescription drug administration may be associated with a patient's body weight, sequencing information of a relevant drug target, other drugs which may cause inter drug effects and/or allergy information.

Medical data from the medical data interface monitor 220 and the staffing tracking unit 215 is transferred, in part or in whole, to the computing unit 225. The computing unit 225 runs an analysis which determines, in real time, when a first of a plurality of medical procedures is required. The first medical procedure is determined according to a plurality of physiological measures. The analysis may be a set of predefined rules and thresholds which determine when a medical procedure is needed. For example, upon prescribing a medication which requires hepatic function monitoring a blood work procedure is suggested. A rule may refer to multiple physiological measurement thresholds. The analysis of the computing unit 225 also determines, in real time, the medical staff members 205 for the medical procedure and the patient. The decision regarding the relevant staff member 205 may be taken with respect to: multiple medical procedures of the same patient taking into account their expected time lines, multiple medical procedures of multiple patients, the history of medical staff member 205 interaction with a patient, follow up assignment to a specific medical staff member 205, correspondence of medical staff members 205 between departments etc. The decision regarding the relevant medical staff member 205 may be a result of optimizing response time, a quality of care and/or a combination thereof. Once the analysis determines when a first of a plurality of medical procedures is required, a messaging unit 230 distributes a message about that medical procedure to the identified relevant medical staff member. The messaging may be distributed through distribution channel 210 as described in FIG. 1. The message contains patient's physiological measurements relevant to the first medical procedure. For example, a message regarding administration of an anticoagulant such as Warfarin may include information about administered antibiotics since some antibiotics, such as ciprofloxacin and clarithromycin, cause drug-drug interactions. The message may further contain non medical information, such as primary insurance company, treatment coverage, secondary insurance (if any), copayment, flexible spending account eligibility, waiting time and/or accompanying family member names and contact details. The message may contain instructions for creating a graphical representation of data to be displayed on a client terminal. Optionally, a memory device 260 storing physiological measurements of patients' medical parameters are connected to the real-time medical staff members' communication system 201. The memory device 260 may be part of a measurement device such as a device measuring heart rate, blood sugar etc. and/or the memory device may be a stand alone memory component connected to a measuring device locally and/or remotely. The memory device may be connected to one or more of staffing tracking unit, computing unit and/or medical data interface monitor.

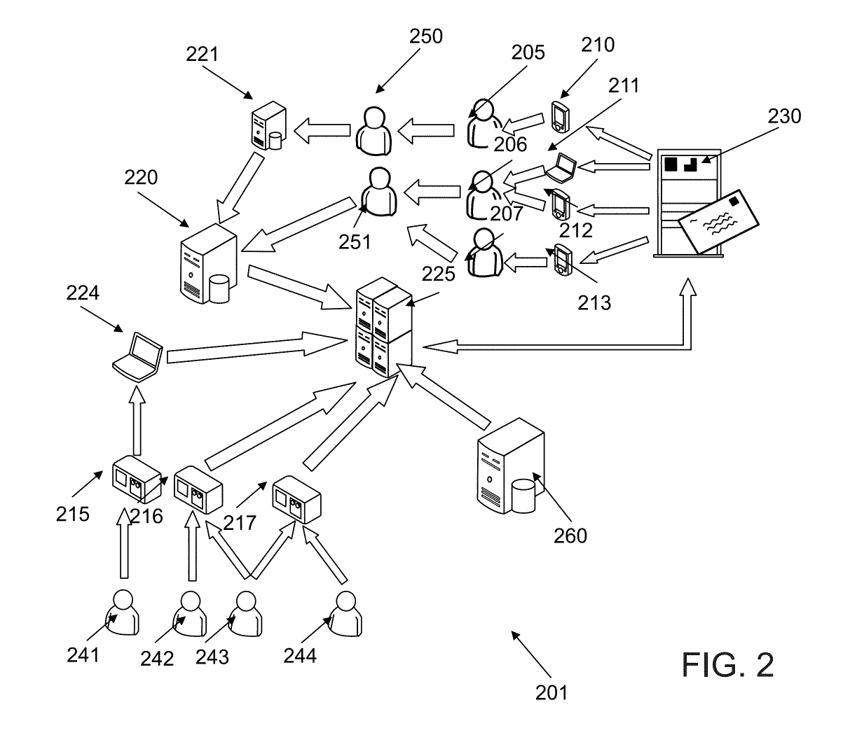

Reference is also made to FIG. 2 which is an illustration of an exemplary implementation of a real-time medical staff members' communication system of identified medical procedures, according to an embodiment of the present invention. Multiple patients 241-244 are being monitored by medical monitors 215-217. The medical monitors may be of similar type 215, 217 or different type 215, 216. A patient 243 may be monitored by multiple medical monitors 216, 217. The physiological parameters measured by the medical monitors may be transferred directly to the computing unit 225 or may first be analyzed locally and/or by an intermediate computation service 224. The computing unit may optimize with respect to a plurality of patients. The messaging unit 230 distributes the messages to handheld devices, personal computers, messaging boards and/or other messages from medical data communication devices 210-213 which receive data from existing medical monitors. A medical staff member 205-207 may be associated with multiple messages medical data communication devices 210-213. The preference of a medical staff member 205-207 for a specific messaging medical data interface monitor may be associated with the time, location, content of message and/or type of message. Messages from the messaging unit may be distributed to messages medical data communication devices 210-213 according to these preferences. A medical staff member 205-207 may be associated with one or more medical roles 250, 251. The current status of the medical staff members 205-207 in active duty of medical roles 250, 251 may be monitored directly by the staffing tracking unit 220 and/or may be first collected by an intermediate staffing tracking unit 221. Some or all of the data regarding medical roles 250, 251 manned medical staff members 205-207 is transferred to the computing unit 225. The computing unit 225 may be a single machine, a cluster, a cloud service, a collection of computing machines and/or a combination thereof.

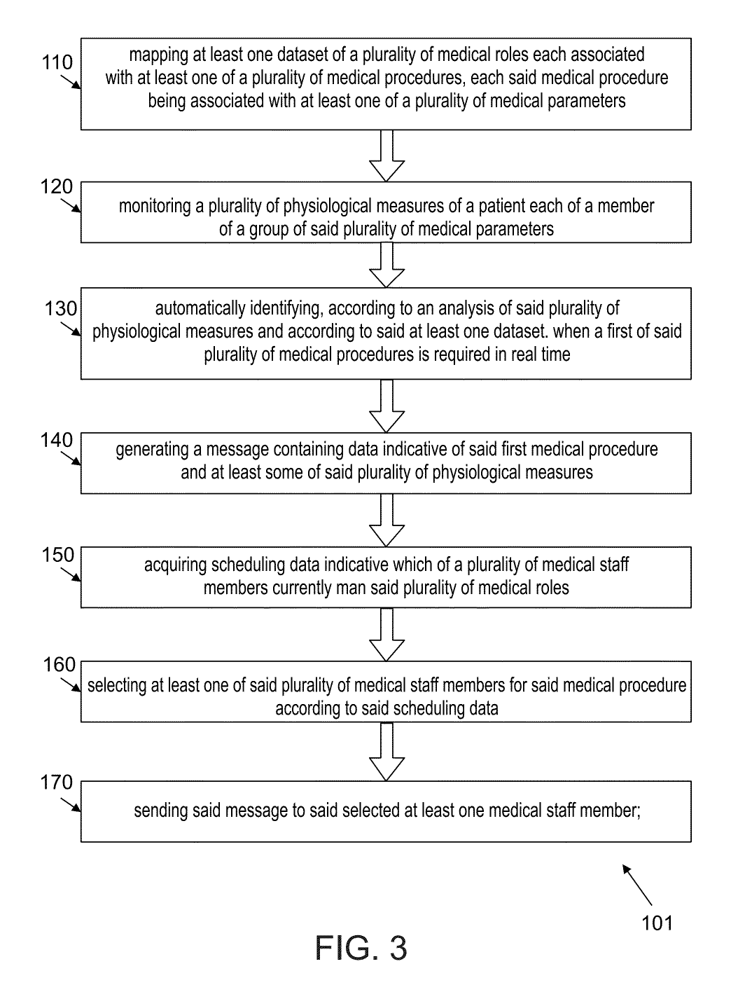

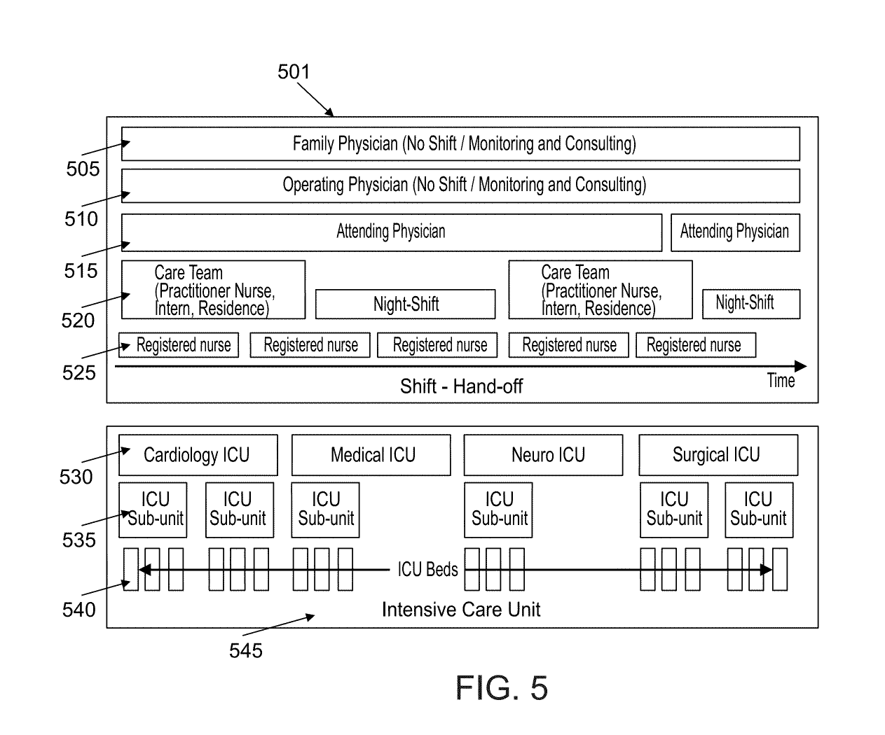

Reference is now made to FIG. 3 which depicts a method for communicating with relevant medical staff members about identified medical procedures in real time, according to an embodiment of the present invention. First, one or more dataset of medical roles is mapped 110. The dataset mapping may be accomplished by reading medical roles data from one or more sources by a staffing tracking unit 220 and revising it to fit the data model used by the communication system's 201 computing unit 225. The data source may be a data system, a web service, and/or a combination thereof. Data may be transferred from the data source into the staffing tracking unit 220 of the communication system 201 by intra-net, internet communication and/or direct connection. The data revision may be performed by coordinating medical dictionaries and/or ontologies, by natural language processing, by reformatting and/or a combination thereof. A plurality of physiological measures of a patient is then monitored. Physiological measures are monitored for each of a member of a group of the plurality of medical parameters. For example, the following physiological measurements are monitored for the medical parameter fetus size: crown-to-rump length (CRL), femur length (FL), biparietal diameter (BPD), head circumference (HC), occipitofrontal diameter (OFD), abdominal circumference (AC) and humerus length (HL). The medical roles dataset mapping may be performed in real time. Next, a medical procedure is automatically identified 130 in real time. The automatic identification is done according to an analysis of the plurality of physiological measures and according to one or more dataset. The automatic identification may be done in real time. The automatic identification of a medical procedure may be triggered by a single physiological measurement above or below a preset threshold, by a gradual change of a physiological measurement, by a combination of physiological measurements, by an action of a medical staff member, a patient check-in, a transfer of a patient between care units and/or a patients report. Next, as shown at 140, a message containing data indicative of the first medical procedure is generated. The message generation may be done in real time. The message contains one or more physiological measures. The physiological measures may be ordered in the message in a predefined order or by their degree of relevance and/or importance to the specific message. Next, scheduling data is acquired 150. The scheduling data acquisition may be done in real time. The scheduling data indicates which of a plurality of medical staff members currently man the plurality of medical roles which are assigned to a current shift. It may also indicate medical staff members to expected man upcoming shifts. Next, one or more of a plurality of medical staff members is selected 160 for the medical procedure. Medical staff members are selected from the pool of available medical staff according to the scheduling data. The medical roles and the mapping of procedures to medical roles narrows down the pool of available medical staff to include only the medical staff members authorized to perform a specific procedure. Next, a message is sent 170 to the selected medical staff member. The message may be sent in real time from a messaging device. The messaging device may be an automated message system and/or a cloud service. The message may be a text message, a short message service (SMS), a multimedia message including video, audio and/or pictures. The message may be received by a phone, a mobile phone, a tablet, a personal computer, a display board, a wireless hand carried device, a laptop, an iPad and/or a personal digital assistant (PDA). Optionally, the message content and/or format may be adjusted to the message receiving device(s). For example, a smart phone message may contain a text alert whereas an iPad may contain a message with a detailed view of multiple measurements that triggered the message. Optionally, the message receiving device(s) may be determined by a user predefined preferences, a user current location, a user recent locations, a user real time preference specifications, a user's working schedule, a track record of responsiveness on different devices at different times to different message types, a user recent responses source and/or a combination thereof. A message may contain medical such as physiological measurement including: blood pressure, oxygen level in blood, temperature, IV liquid level etc. obtained by a medical data interface monitor. The message can also contain non medical information such as the physician on floor, insurance type, insurance maximal coverage for a certain condition etc. The content of the message may be obtained by a medical data interface monitor, by a medical staff member report of a measurement to the staffing tracking unit 220 of the communication system 201, by data acquired by the staffing tracking unit 220 and/or data computed by the computing unit 225 of the communication system 201. The content of the message may be raw data such as a single exact measurement of a physiological parameter and/or an inferred data such as a gradual decline in a physiological measurement over time. Inferred data is, for example, the overall intake of fluids versus the overall output of fluids. A growing difference between the overall fluid intake and output may indicate fluid retention and/or fluid loss. The information may be presented in numeric form, in graphical form and/or as linkage. The message may aggregate information about one or more patient. For example, a certain medical procedure such as urine sampling is needed for patient 1. The message may contain information about other patients, say patients 2 and 3, which are in physical proximity to patient 1 that need the same medical procedure, to assist in efficient sampling. The message may aggregate information of one or more procedures for the same patient. Optionally, failure to response to a message triggers selection of a different medical staff member in real time until the required procedure is performed. Optionally, statistics about response times, type and/or number of procedures performed are saved and analyzed by the communication system 201. Optionally, a transition between medical staff members shifts is being managed by the communication system 201. A user 207 may sign in and out by sending a message from a medical data communication device 213. The message may be received by the messaging unit 230. The messaging unit 230 communicates with the computing unit 225 to determine the status of the transition process. Each medical role may have a minimum number of medical staff members and each medical staff member is assigned one of the states: active, active in transition, off-duty, off-duty in transition. Each medical role is manned by at least the minimum number of medical staff members. The state transition may be performed as described in FIG. 5. Optionally, the medical stuff scheduling data, the selection of the relevant medical stuff member(s) and/or the required medical procedures are organized in a patient centric manner. As the patient is the one who endures and/or benefits from the health care quality the information is organized around this entity. This data rearrangement enables to provide the right attention from the right care giver for the right treatment. Optionally, the response of a medical staff member to a message is monitored. The response may be a confirmation message, a content baring message such as text, code(s), a picture and the like, assignment to a different medical staff member, consulting with anther medical staff member and/or forwarding to another medical staff member. The response may describe an action taken, declaration of intent such as: postponing of action to a future time and/or declining procedure. Monitoring responses to messages enables tracking unhandled messages. To ensure continuation of care, unhandled messages are redirected to current shift medical staff members upon a transition between medical staff members shifts. Optionally, unhandled messages trigger an escalation. The escalation may be redirecting message to another medical staff member of a similar role, redirecting message to another medical staff member of another role with a higher rank, broadcasting a message and/or sending another message to the same medical staff member with different content. Optionally, the communication between medical staff member is a bi-directional and/or multi-directional. A receiver of a message may respond to the message, forward the message and/or facilitate a channel of communication for multiple participants. The response to a message may be in the same communication form as the original message and/or in a different form. For example the original message may be an email and the response may be a chat. Response types comprise instant messaging, texting, email and/or phone calls. Brining the message, part of the message, a summary of the message and/or notes about the message to the attention of another medical staff member may facilitate a professional collaboration. Bringing the message to the attention of another medical staff member may be performed by forwarding the message, creating another message based on the content of the first message and/or sharing a communication channel with the other medical staff member.

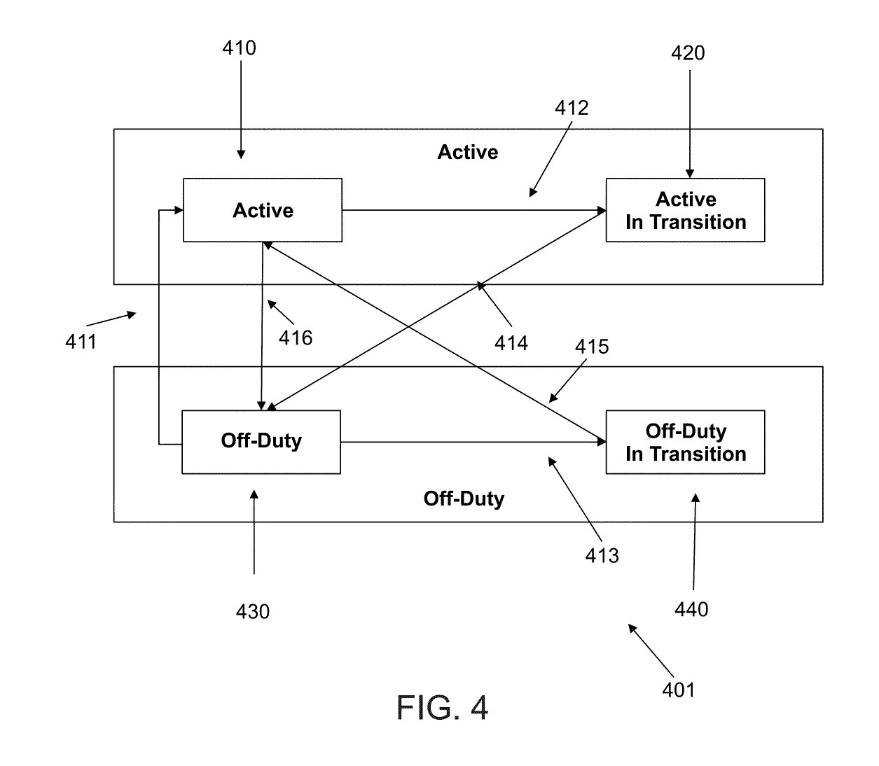

Reference is also made to FIG. 4 which is an illustration of a medical staff member status transition upon signing in to a communication system, according to an embodiment of the present invention. A medical staff member in active duty 410 may go off-duty in one of two routes: direct to off-duty 416 or indirect to off-duty 412, 414 as explained below. If another medical staff members man the medical role, the active medical staff member 410 may go directly 416 from active 410 to off-duty 430; however, if no replacement medical staff member signed in for the medical role, the active staff member goes from active 410 to active in transition 420 upon signing off. Once anther medical staff member signs in for the medical role, the status is changed 414 from active in transition to off-duty 430. An off duty medical staff member 430 can become active in one of two routes: direct 411 and indirect 413, 415. If the medical role is manned by one (or more) medical staff members(s) who are active in transition the newly joining medical staff member can go directly 411 from off-duty 430 to active 410 status; however, if the medical role is manned by active medical staff members, the newly joined medical staff member is assigned an off-duty in transition status 440 upon sign in. When the status of a medical staff member becomes off-duty, the off-duty in transition status 440 becomes active 410 by the indirect route 415.

Reference is also made to FIG. 5 which is an illustration of medical staff member information 501 and physical organization data of a care unit 545 utilized for selecting one or more medical staff member for a medical procedure, according to an embodiment of the present invention. The plurality of medical staff members 525 that currently man a plurality of medical roles 520 are monitored by a staffing tracking unit 215. The physical organization of the care unit 545 comprises units such as cardiology, neurologic and surgical 530, sub-units 535 and patient beds 540. The care unit physical organization information may be combined with staff member shift information 515, 520, 525 and non shift information such as family physician 505 and/or operating physician 510. The medical staff member information 501 and/or physical organization data of a care unit 545 may be dynamically monitored by a staffing tracking unit 215 and/or saved in static fashion with periodic updates. This information 501, 545 may be utilized for selecting one or more medical staff member for a medical procedure, according to an embodiment of the present invention. Previous familiarity with the patient case, time on shift, seniority, professional relation with family physician and similar considerations may contribute to the selection of the medical staff member to be notified of a medical procedure.

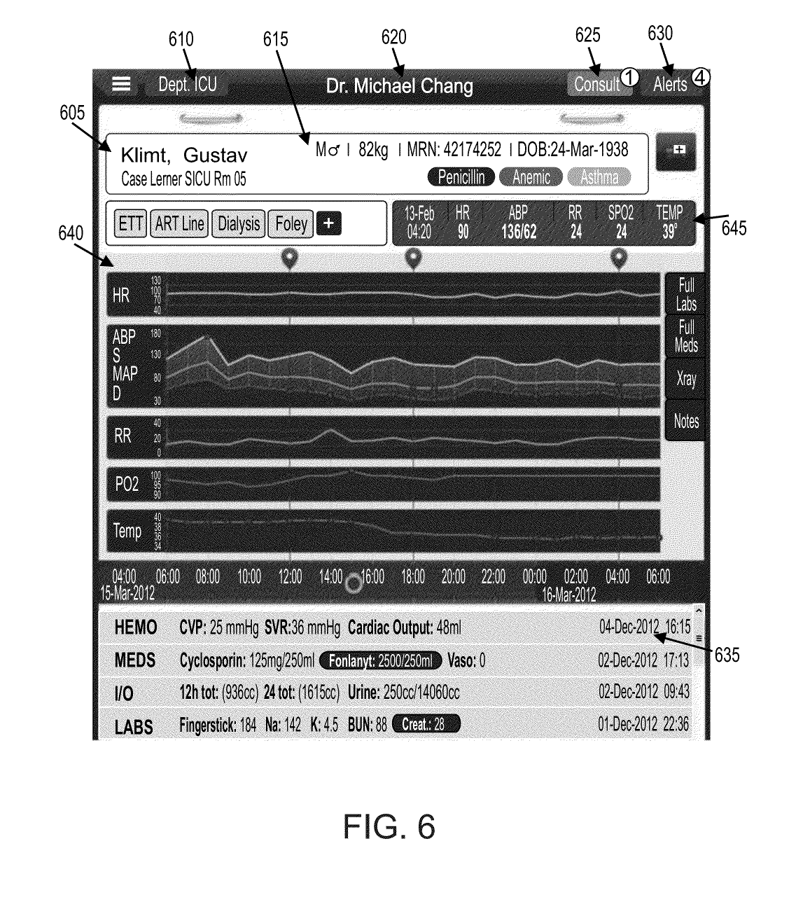

Reference is also made to FIG. 6 which is a screen shot of an application implementing a real-time medical staff members' communication system of identified medical procedures, according to an embodiment of the present invention. The patient name and care unit affiliation is displayed 605. The location of the medical role 610, for example, a department ICU, is displayed. Optionally, the location where the medical role is played may be changed. Relevant medical and non medical information about a patient 615 such as gender, weight, age, medical record number, allergies and/or medical conditions is summarized and displayed. The care giving medical staff member is displayed 620. Consultation requests 625 and alerts 630 are provided. Physiological parameters are summarized in a numeric manner 645 and/or in a graphical manner 640. Physiological parameters from different medical data communication devices 215 may be presented on a single timeline for providing a complete picture of a patient's condition and/or assist in identifying relations between events and measurements. Medical history 635 may be provided in the form of events and/or broken down subjects such as lab results, medications, checkups etc.

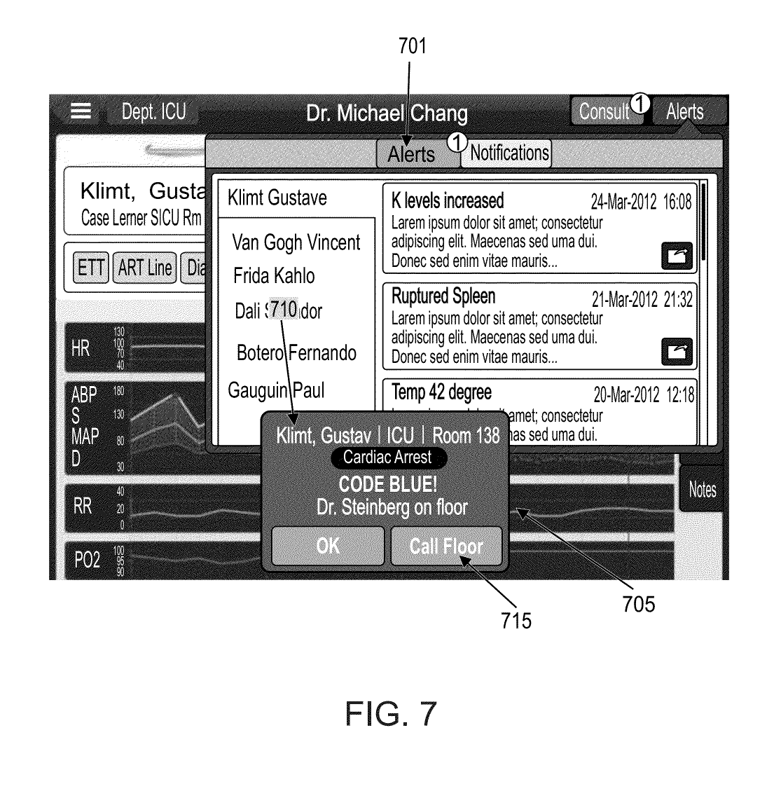

Reference is also made to FIG. 7 which is an illustration of a message for a medical staff member, according to an embodiment of the present invention. The message is displayed, for example, as a pop up message on a screen of a hand held wireless device. Optionally, the message may be sent as a multimedia message (MMS) to a mobile phone or displayed on an electronic message board placed in a care unit. If the message is urgent the display screen 701 may be dimmed to highlight the urgent message 705. The message 705 may contain a patient's identity and accompanying medical and non-medical information 710 such as physical location of patient's bed, physiological measurement causing the alert, alternative medical staff members etc. The message is optionally accompanied by actionable information 715 such as calling a department, notify a collaborator and/or order a drug etc.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

It is expected that during the life of a patent maturing from this application many relevant medical measurement devices, medical data interface monitor and messaging units will be developed and the scope of the terms measurement devices, medical data interface monitor and messaging unit s are intended to include all such new technologies a priori.

As used herein the term “about” refers to ±10%. The terms “comprises”, “comprising”, “includes”, “including”, “having” and their conjugates mean “including but not limited to”. This term encompasses the terms “consisting of” and “consisting essentially of”. The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for communicating with relevant medical staff members about identified medical procedures in real time, comprising:
monitoring a plurality of medical parameters of a patient during the hospitalization thereof;
mapping each of a plurality of medical roles to at least one of a plurality of medical procedures, each said medical procedure being associated with at least one of said plurality of current medical parameters;
automatically identifying in real time, according to an analysis of said plurality of current medical parameters, when a first of said plurality of medical procedures is required;
acquiring scheduling data indicative which of a plurality of medical staff members currently man said plurality of medical roles;
generating a message containing data indicative of said first medical procedure and at least some of said plurality of medical parameters which are relevant for said first medical procedure;
selecting at least one of said plurality of medical staff members for said medical procedure according to said scheduling data; and
sending said message to said selected at least one medical staff member.

2. The method of claim 1, wherein said plurality of medical parameters are extracted from at least one medical monitor which monitors said patient.

3. The method of claim 1, wherein said plurality of medical parameters comprises a member of a group consisting of a blood pressure, an oxygen level in blood, a temperature, and an IV liquid level.

4. The method of claim 1, wherein said scheduling data is indicative which of said plurality of medical staff members' man said plurality of medical roles in a plurality of shifts.

5. The method of claim 1, further comprising monitoring a plurality of other patients wherein said selecting at least one of said plurality of medical staff members is optimized with respect to a plurality of medical procedures of said plurality of patients.

6. The method of claim 1, wherein at least one of said monitoring, said automatically identifying, said generating a message, said acquiring, said scheduling data said selecting and said sending is performed in real time.

7. The method of claim 1, further comprising managing a transition between medical staff members shifts wherein each said medical role has a minimum number of medical staff members and each medical staff member is assigned one of the states: active, active in transition, off-duty, off-duty in transition such that each said plurality of medical roles is manned by at least said minimum number of medical staff members.

8. The method of claim 1, further comprising organizing at least one of said required plurality of medical procedures, said acquired scheduling data and selected medical staff members around a patient entity.

9. The method of claim 1, further comprising monitoring a response to said message.

10. The method of claim 9, further comprising ensuring continuation of care by redirecting unhandled messages at a transition between medical staff members shifts.

11. The method of claim 9, further comprising managing escalation of an unhandled message according to said response monitoring.

12. The method of claim 1, further comprising facilitating multidirectional communication between said selected at least one medical staff member.

13. The method of claim 1, further comprising forwarding said message to another medical staff member for facilitating collaboration.

14. A real-time medical staff members' communication system of identified medical procedures, comprising:
a medical data interface which receives a plurality of physiological measures for medical parameters of a patient from at least one medical monitor;
a staffing tracking unit which monitors which of a plurality of medical staff members currently man a plurality of medical roles, each said medical role being associated with at least one of a plurality of medical procedures each said medical procedure being associated with a plurality of physiological parameters of said plurality of medical parameters;
a computing unit which determines in real time when a first of said plurality of medical procedures is required according to said plurality of physiological measures and selects, in real time, selects a group from said plurality of medical staff members currently which currently man said plurality of medical roles according to said first medical procedure; and
a messaging unit which distributes at least one message about said first medical procedure to each member of said group;
wherein said message contains patient's physiological measurements relevant to said first medical procedure.

15. The system of claim 14, wherein said at least one message comprises a plurality of messages each adjusted to include a different segment of said plurality of physiological measures.

16. The system of claim 14, wherein said message is selected from a group consisting of: a short message service (SMS) and a multimedia message.
